(19) United States
(12) Patent Application Publication
(10) Pub. No.: US 2008/0297530 A1
(43) Pub. Date: Dec. 4, 2008

(54) Four primary color display apparatus and method

(76) Inventor: Monte Jerome Ramstad, Cannon Falls, MN (US)

Correspondence Address: Dr. Monte Jerome Ramstad, 211 Ridgecrest Drive, Cannon Falls, MN, 55009, US

(21) Appl. No.: 12/156,536

(22) Filed: Jun. 2, 2008

Related U.S. Application Data
(60) Provisional application No. 60/932,354, filed on May 31, 2007.

(51) Int. Cl. G09G 5/02

(52) U.S. Cl. 345/589

(57) ABSTRACT

A yellow primary color is used to increase the brightness of images displayed in four primary colors including red, green, blue and yellow primary colors. The yellow primary color may have a luminosity approximately equal to the luminosity of the red primary color or less, and not contribute substantially to the color gamut. A white primary color may be comprised of yellow light in the region near 570 to 590 nm and cyan light in the region near 475 to 485 nm. A blue primary color may be comprised of light shorter than about 475 nm and light longer than about 500 nm.

### CROSS-REFERENCE TO RELATED APPLICATIONS

Provisional patent U.S. 60/932,354 filed May 31, 2007 titled “FULL-COLOR ANAGLYPHIC STEREOSCOPIC DISPLAY METHOD” by inventor Monte Jerome Ramstad.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

A white primary color may be provided in a display apparatus comprising red, green and blue primary colors in order to increase the brightness of the display apparatus. White light from a white primary color may be preferred to white light from a combination of red, green and blue primary colors due to the greater efficiency of the white primary color. However, a disadvantage of using a white primary color to increase the brightness of a display is that colors with high saturation may not be brightened using the white primary color without desaturating the colors. Instead, the white primary color is preferentially used to increase the brightness of desaturated colors. Another disadvantage in some display types is that the white primary color may take light away from the red, green, and blue primary colors.

Four or more primary colors may be provided in a display apparatus comprising red, green and blue primary colors plus additional primary colors in order to increase the color gamut of the display apparatus. The additional primary colors may be optimally selected in order to increase the color gamut of the display apparatus. The red, green and blue primary colors are often selected to be more saturated and less bright than could be provided by the same light sources without the extra primary colors. In general, the overall brightness of the display may be reduced by the additional primary colors while the color gamut is increased.

In general, the prior art demonstrates a trade-off between color gamut and brightness of a display apparatus. Various display apparatus have various tradeoff issues. However, there is a need for additional methods to increase the brightness of various display apparatus using a fourth primary color without reducing the saturation of colors.

### BRIEF SUMMARY OF THE INVENTION

One embodiment of the present invention provides a method to increase the brightness of a display apparatus comprising four primary colors. The display apparatus provides red, green, blue and yellow primary colors. The yellow primary color may be comprised of light in regions of the visible spectrum which may be substantially devoid of the red, green and blue primary colors. The yellow primary color may be used to brighten the highly saturated red and green colors by shifting the hues of the high luminance red and green colors toward yellow. The highly saturated blue colors may be (1) left largely unchanged; (2) brightened with additional blue light; or (3) brightened by green light by shifting the blue colors toward cyan. The additional blue or green light may be used to create a brighter effective blue primary color. If the blue primary color is unchanged, the effective white point of a display apparatus may be shifted toward lower temperature by the yellow primary color. If the effective blue primary color is brightened by additional blue light, the white point of a display apparatus may be substantially unchanged. If the effective blue primary color is brightened using green light, the effective white point may be shifted toward green. On the other hand, color transformations may be used to preserve a natural white point while the highly saturated blue colors are shifted toward green.

In another embodiment of the present invention, the brightness of a display apparatus may be increased by providing a white primary color comprising light in regions of the visible spectrum which may be substantially devoid of the red, green, and blue primary colors. The white primary color may be comprised of yellow light with a spectra between the spectra of the red and green primary colors. The white primary color may also be comprised of cyan light with a spectra between the spectra of the green and blue primary colors. Alternatively, the white primary color may be comprised of blue light with a spectra centered near 480 nm and yellow light with a spectra centered near 580 nm in order to produce a natural white primary color. If the white primary color is comprised of light near 480 nm, the blue primary color may be comprised of blue light shorter than about 480 nm and green light longer than 480 nm. In other words, green light may be used in the blue primary color in order to compensate for blue light transferred to the white primary color.

### BRIEF DESCRIPTION OF THE SEVERAL VIEWS OF THE DRAWING

FIG. 1 depicts representative spectra of a red R, a green G, a blue B, and a white W primary color.

FIG. 2 depicts representative spectra of a red R, a green G, a blue B, and a narrow yellow Y primary color.

FIG. 3 depicts representative spectra of a red R, a green G, a blue B, and a wide yellow Y primary color.

FIG. 4 depicts representative spectra of a red R, a green G, a blue B, and a narrow yellow Y primary color. The blue primary color has additional blue light.

FIG. 5 depicts representative spectra of a red R, a green G, a blue B a cyan B′ primary color, and a narrow yellow Y primary color. The blue primary color has additional green light.

FIG. 6 depicts the saturation of a red S₁, a green S₃, and a blue S₃ primary color as a function of an added white primary color.

FIG. 7 depicts the saturation of a red S₁, a green S₃, and a blue S₃ primary color as a function of an added yellow primary color.

FIG. 8 depicts a mapping M of color coordinate p′ᵢ of primary color Pᵢ into coordinates (pᵢ yᵢ) of primary color Pᵢ and yellow primary color P_{y}.

FIG. 9a depicts the luminosity Y_{L} and chromaticity r-g of red and green primary colors {P₁,P₂} and effective primary colors {P′₁,P′₂} as a function of added yellow primary color P_{y}.

FIG. 9b depicts the luminosity Y_{L} and chromaticity y-b of red, green and blue primary colors {P₁,P₂,P₃} and effective primary colors {P′₁,P′₂,P′₃} as a function of added yellow and white primary colors.

FIG. 10 depicts the color gamut of red, green and blue primary colors {P₁,P₂,P₃} of the SRGB color space and effective primary colors {P′₁,P′₂,P′₃} as a function of added yellow and white primary colors.

FIG. 11 depicts the color gamut of red, green and blue primary colors {P₁,P₂,P₃} of the DCI specification and effective primary colors {P′₁,P′₂,P′₃} as a function of added yellow and white primary colors.

FIG. 12 depicts a pixel format having four primary colors red R, green G, blue B, and yellow Y.

FIG. 13 depicts an array of red R, green G, blue B, and yellow Y light sources.

FIG. 14 depicts the back light of an LCD display panel which provides red, green, blue and yellow subpixel colors.

FIG. 15 depicts an optical assembly for a projector with a single display panel and multiple light sources including a red, a green, a blue, and a yellow light source.

FIG. 16a depicts an optical assembly for a projector with a single LCD panel and a color wheel of filters providing red, green, blue and yellow segments of light.

FIG. 16b depicts a color wheel of filters providing red, green, blue and yellow segments of light.

FIG. 17 depicts an optical assemble for a four panel LCOS projector.

### DETAILED DESCRIPTION OF THE INVENTION

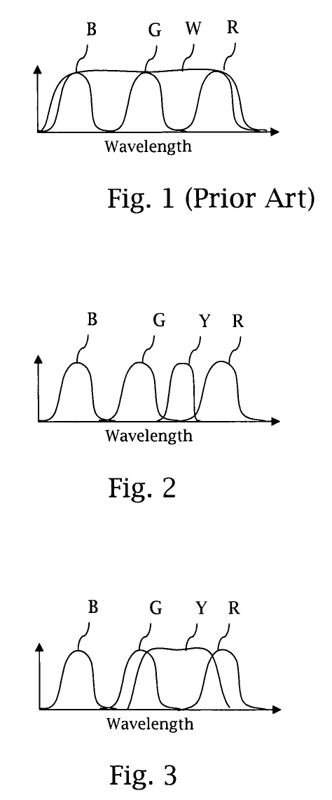

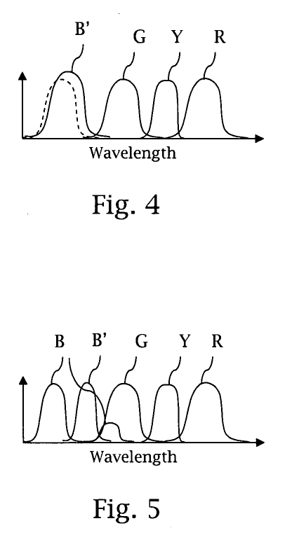

FIG. 1 depicts the spectra of red R, green G, blue B and white W primary colors provided by a display apparatus of the prior art where the white primary color is used to increase the brightness of the display apparatus. Use of the white primary color is usually constrained by the desire to not desaturate the colors of a color image. FIG. 2 depicts the spectra of red R, green G, blue B, and yellow Y primary colors which may be used in the present invention to increase the brightness of a display apparatus without desaturating the colors in a color image. In FIG. 2, the spectra of the yellow Y primary color does not substantially overlap the spectra of the red R and green G primary colors. Certain types of display apparatus may conveniently produce a yellow primary color which does not overlap the spectra of the red R and green G primary colors. FIG. 3 depicts an alternate set of spectra in which the spectra of the yellow primary color substantially overlaps the spectra of the red R and green G primary colors. Certain types of display apparatus may conveniently produce a yellow primary color which overlaps the spectra of the red R and green G primary colors. FIG. 4 depicts the spectra of red R, green G, blue B and yellow Y primary colors provided by a display apparatus capable of providing additional blue light to the blue B primary color. The additional blue light may be used by the present invention to adjust or maintain the white point of the display apparatus near the white point of the red R, green G, and blue B primary colors in the presence of light from the yellow primary color.

It is a common practice to store image data in coordinates {a₁,a₂,a₃} representing the values of three primary colors {A₁,A₂,A₃}. The coordinates represent specific colors which may be comprised in a triangular color gamut with vertices representing the three primary colors A₁,A₂, and A₃ in a CIE xy chromaticity diagram. A display apparatus may approximate the colors represented by the coordinates {a₁,a₂,a₃} when displaying an image in three or more primary colors {P₁, . . . ,Pₘ}. Sometimes an image may be stored in coordinates {c₁,c₂,c₃} such as in {x,y,Y} coordinates of the CIE xyY color space which may be transformed into coordinates {a₁,a₂,a₃} of primary colors {A₁,A₂,A₃}. The colors represented in the coordinates {c₁,c₂,c₃} may be comprised in the color gamut of the primary colors {A₁,A₂,A₃}.

When a display apparatus provides four or more primary colors {P₁, . . . ,Pₘ}, the shape of the color gamut of the primary colors {P₁, . . . ,Pₘ} may be different from the shape of the color gamut of the primary colors {A₁,A₂,A₃}. More generally, the three-dimensional shape of the color space of the primary colors {P₁, . . . ,Pₘ} may be different from the three-dimensional shape of the color space of the primary colors {A₁,A₂,A₃}. In these cases, a display apparatus may display an image in colors which may be systematically different from the colors represented in the coordinates {A₁,A₂,A₃}. The coordinates {a₁,a₂,a₃} of primary colors {A₁,A₂,A₃} may represent a color {a₁A₁,a₂A₂,a₃A₃}. The coordinates {p₁, . . . ,pₘ} of primary colors {P₁, . . . ,Pₘ} may represent a color {p₁P₁, . . . ,pₘPₘ}. In general, a plethora of transformations H may be considered for transforming colors {a₁A₁,a₂A₂,a₃A₃} into colors {p₁P₁, . . . ,pₘPₘ}. A transformation H may be given by a set of functions pᵢ=Hᵢ(a₁,a₂,a₃). If four primary colors of a display apparatus {P₁,P₂,P₃,P₄} are designed to provide a wide color gamut, a transformation H which increases the color gamut of the colors may be preferred. If four primary colors of a display apparatus {P₁,P₂,P₃,P₄} are designed to provide enhanced brightness, a transformation H which increases the image brightness may be preferred.

A primary color Pᵢ may be described by its coordinates {Rᵢ,Gᵢ,Bᵢ} in the CIE RGB color space. The coordinates {Rᵢ,Gᵢ,Bᵢ} may be determined from the CIE color matching functions by methods well known to those skilled in the art. The chromaticity coordinates {rᵢ,gᵢ,bᵢ}of each primary color may be defined by

rᵢ=Rᵢ/(Rᵢ+Gᵢ+Bᵢ),

gᵢ=Gᵢ/(Rᵢ+Gᵢ+Bᵢ), and

bᵢ=Bᵢ/(Rᵢ+Gᵢ+Bᵢ).

The saturation Sᵢ of a primary color may be related to the largest chromaticity coordinate max(rᵢ,gᵢ,bᵢ) and the smallest chromaticity coordinate min(rᵢ,gᵢ,bᵢ). The smallest chromaticity coordinate represents the grayness of a color. The saturation may be represented by

Sᵢ=100*(max(rᵢ,gᵢ,bᵢ)−min(rᵢ,gᵢ,bᵢ))/max(rᵢ,gᵢ,bᵢ).

If a fourth primary color P₄ does not substantially expand the color gamut of the primary colors {P₁,P₂,P₃}, it is useful to consider a mapping M of the primary colors {P₁,P₂,P₃} into effective primary colors {P′₁,P′₂,P′₃} represented as follows:

P′₁=P₁+λ₁P₄,

P′₂=P₂+λ₂P₄, and

P′₃=P₃+λ₃P₄.

The color gamut of the primary colors {P′₁,P′₂,P′₃} and the color gamut of the primary colors {P₁,P₂,P₃} provide an indication of the tradeoff between increasing the brightness and decreasing the color gamut provided by the primary color P₄.

A white primary color P₄ may be represented by CIE RGB coordinates {R_{w},G_{w},B_{w}} where the R_{w}, G_{w}, and B_{w} may be scaled so that the luminosity Y_{Lw} of primary color P₄ is equal to one, Y_{Lw}=1. Similarly, the sRGB primary colors may be scaled so that the white point of the sRGB primary colors has a luminosity Y_{Ls} equal to one, Y_{Ls}=1. The white point of a set of primary colors is the color created by combining all the primary colors in the set. Then the CIE RGB coordinates of an effective primary color P′ᵢ may be represented by

R′ᵢ=Rᵢ+λᵢR_{w},

G′ᵢ=Gᵢ+λᵢG_{w}, and

B′ᵢ=Bᵢ+λᵢB_{w}.

The chromaticity coordinates of the effective primary color P′ᵢ may be represented by

r′ᵢ=(Rᵢ+λᵢR_{w})/(Rᵢ+Gᵢ+Bᵢ+λᵢ(R_{w}+G_{w}+B_{w})),

g′ᵢ=(Gᵢ+λᵢG_{w})/(Rᵢ+Gᵢ+Bᵢ+λᵢ(R_{w}+G_{w}+B_{w})), and

b′ᵢ=(Bᵢ+λᵢB_{w})/(Rᵢ+Gᵢ+Bᵢ+λᵢ(R_{w}+G_{w}+B_{w}))

from which the saturation Sᵢ of the primary color P′ᵢ may be determined as a function of the amount λᵢ of the primary color P₄.

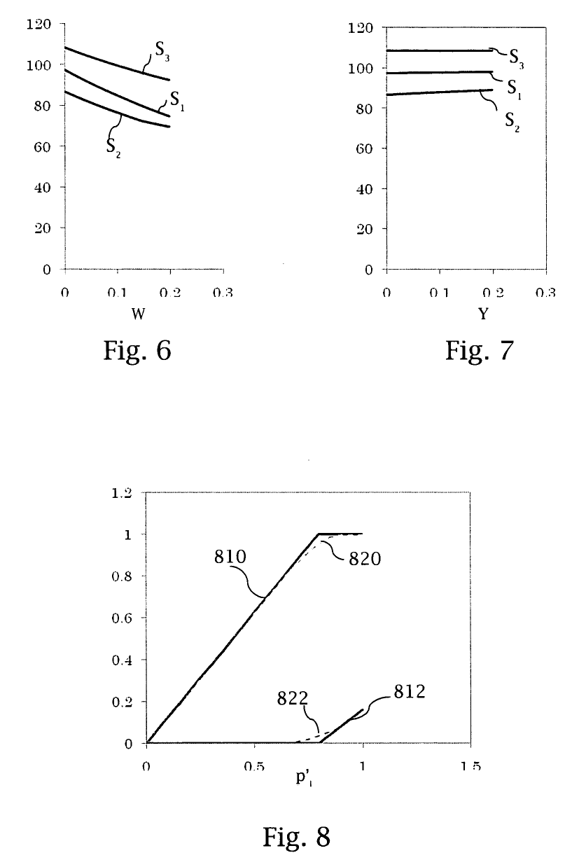

FIG. 6 shows an example of the saturations {S₁,S₂,S₃} of the primary colors {Rₛ,Gₛ,Bₛ} of the sRGB color space due the addition of a white primary color which is proportional to the sRGB white point. In FIG. 6, W=λ₁=λ₂=λ₃ is the luminosity added to each primary color {Rₛ,Gₛ,Bₛ The sRGB color space uses the ITU-R BT.709-5 primary colors, which are used in studio monitors and HDTV,[International Color Consortium]. The CIE RGB coordinates of the sRGB primary colors and white point are as follows:

| | R | G | B |
|---|---|---|---|
| Rₛ: | (0.77555, | 0.0925, | 0.01856) |
| Gₛ: | (0.14858, | 0.84653, | 0.11185) |
| Bₛ: | (−0.08283, | 0.09435, | 0.9591) |
| Wₛₚ: | (0.842325, | 1.033399, | 1.089557). |

FIG. 6 shows that the saturations {S₁,S₂,S₃} of the primary colors {R′ₛ,G′ₛ′,B′ₛ} decrease rapidly as the luminosity W of the white primary color P₄ is increased. For this reason, the use of a white primary color to increase the brightness of highly saturated colors is usually limited in the prior art.

One embodiment of the present invention provides methods of increasing the brightness of a display apparatus providing red P₁, green P₂, blue P₃ and yellow P_{y} primary colors, where the three primary colors {P₁,P₂,P₃} provide a color gamut substantially capable of representing the color gamut of an image. In the present embodiment, the yellow primary color P_{y} may be primarily used to increase the brightness of the primary colors of a display apparatus rather than to increase the color gamut of the display apparatus. For this reason, the primary colors {P₁,P₂,P₃} provide a sufficient color gamut to display color images. The yellow primary color P_{y} may be about as bright as the red primary color or less bright and may contribute only a small amount to the color gamut of the display apparatus. For example, the primary colors {P₁,P₂,P₃} may be close to the primary colors of the sRGB colorspace or may be close to the primary colors specified by the DCI specification and the yellow primary color may have a spectra centered near 570-580 nm and be comprised of the yellow light which is often discarded from the spectra of a light source such as a UHP lamp or Xenon lamp.

In one method of the present embodiment, a yellow primary color P₄=P_{y} may be added to the red P₁ and green P₂ primary colors and the blue primary color P₃ may be brightened using the additional blue primary color light as follows:

P′₁=P₁+λ₁P₄,

P′₂=P₂+λ₂P₄, and

P′₃=(1+λ₃)P₃.

The color gamut of the primary colors {P′₁,P′₂,P′₃} and the color gamut of the primary colors {P₁,P₂,P₃} provide an indication of the tradeoff between increasing the brightness and decreasing the color gamut provided by the yellow primary color P_{y}. A yellow primary color P_{y} may be represented by CIE RGB coordinates {R_{y},G_{y},B_{y}} where the R_{y}, G_{y}, and B_{y} may be scaled so that the luminosity YLy of primary color P_{y} is equal to one, Y_{Ly}=1. Then the CIE RGB coordinates of the red and green primary colors P′ᵢ may be represented by

R′ᵢ=Rᵢ+λᵢR_{y},

G′ᵢ=Gᵢ+λᵢG_{y}, and

B′ᵢ=Bᵢ+λᵢB_{y}.

The chromaticity coordinates of the red and green primary colors P′ᵢ may be represented by

r′ᵢ=(Rᵢ+λᵢR_{y})/(Rᵢ+Gᵢ+Bᵢ+λᵢ(R_{y}+G_{y}+B_{y})

g′ᵢ=(Gᵢ+λᵢG_{y})/(Rᵢ+Gᵢ+Bᵢ+λᵢ(R_{y}+G_{y}+B_{y})), and

b′ᵢ=(Bᵢ+λᵢB_{y})/(Rᵢ+Gᵢ+Bᵢ+λᵢ(R_{y}+G_{y}+B_{y}))

from which the saturation Sᵢ of the red and green primary colors P′ᵢ may be determined as a function of λᵢ. The coordinates λᵢ are the luminosity added to each primary color Pᵢ by the yellow primary color P_{y}.

The CIE RGB coordinates of the blue primary color P′₃ may be represented by

R′₃=(1+λ₃)R₃,

G′₃=(1+λ₃)G₃, and

B′₃=(1+λ₃)B₃.

The chromaticity coordinates of the blue primary color P′₃ may be represented by

r′₃=R₃/(R₃+G₃+B₃),

g′₃=G₃/(R₃+G₃+B₃), and

b′₃=B₃/(R₃+G₃+B₃)

from which the saturation S₃ of the blue primary colors P′₃ may be determined as a function of λ₃. Note that the saturation S₃ is independent of the amount λ₃ of additional blue light. λ₃P₃ is the additional blue light added to the blue primary color P₃. In general, λ₃ may be chosen in order to preserve the white point of the display apparatus. The ratio Of λ₁:λ₂ may be preferably equal to the ratio of the luminosities of primary colors {P₁,P₂}.

FIG. 7 shows an example of the saturations {S₁,S₂,S₃} of the primary colors {Rₛ,Gₛ,Bₛ} of the sRGB color space due the addition of the yellow primary color P_{y}, In FIG. 7, Y=λ₁=λ₂=λ₃ is the amount of light added to each primary color {Rₛ, Gₛ,Bₛ}. The yellow primary color P_{y} was chosen to have CIE RGB coordinates of about

| | R | G | B |
|---|---|---|---|
| P_{y}: | (1.430735, | 0.919373, | −0.000733) |

and may have a narrow spectra centered near 577.5 nm. FIG. 7 shows that the saturation of the primary colors {R′ₛ,G′ₛ,B′ₛ} is nearly unchanged as the amount Y of the yellow primary color P_{y} is increased.

FIGS. 6 and 7 demonstrate that a yellow primary color P_{y} may be added to the primary colors {Rₛ,Gₛ} without causing desaturation of the primary colors {Rₛ,Gₛ,Bₛ} whereas a white primary color added to primary colors {Rₛ,Gₛ,Bₛ} may cause desaturation of the primary colors.

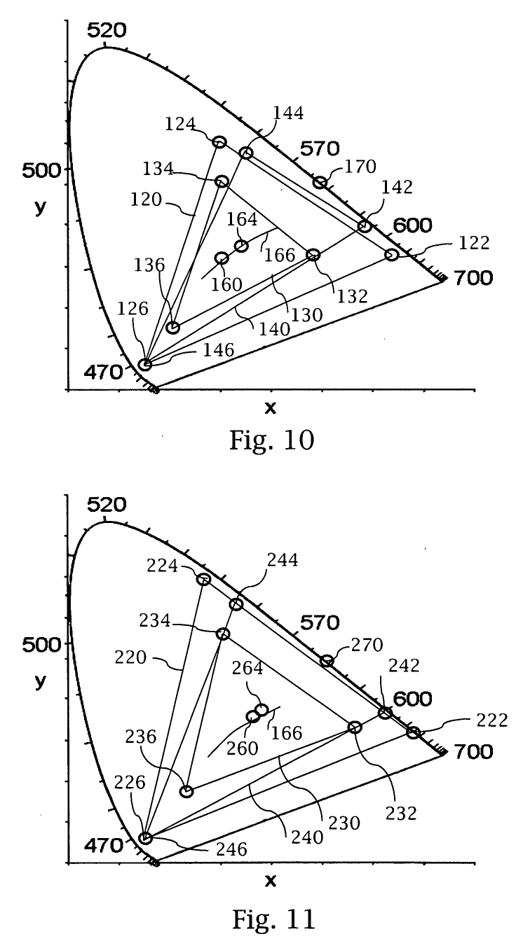

FIG. 10 shows (1) the color gamut 120 of the primary colors Rₛ 122, Gₛ 124, and Bₛ 126; (2) the color gamut 130 of the effective primary colors Rₛ′ 132, Gₛ′ 134, and Bₛ′ 136 for a white primary color P₄ with a luminosity W of 0.2; and (3) the color gamut 140 of the effective primary colors Rₛ′ 142, Gₛ′ 144, and Bₛ′ 146 for a yellow primary color P_{y} with a luminosity Y of 0.2. The color gamut 130 resulting from adding the white primary color P₄ is reduced in area and saturation compared with the color gamut 120 of the sRGB primary colors. For this reason, some methods of the prior art of brightening an image using a white primary color generally avoid brightening the highly saturated colors. The color gamut 140 resulting from adding a yellow primary color P_{y} is reduced in area compared with the color gamut 120 of the sRGB primary colors however, the saturation is not significantly reduced. The color gamut 140 with the added yellow primary color P_{y} has slightly more chromaticity in the yellow hue region than the color gamut 120 of the sRGB primary colors. The color gamut 140 may provide slightly brighter yellow and orange hues. However, some of the additional yellow and orange hues may be used to represent more reddish and greenish hues of an image. Therefore, the red and green hues may be brightened to levels similar to the brighter yellow and orange hues. The point 150 of pure yellow primary color P_{y} in FIG. 10 occurs when only the coordinate of the primary color P_{y} is non-zero. However, the luminosity of the primary color P_{y} is relatively small so that in practice, the color gamut of the primary colors {Rₛ,Gₛ,Bₛ,P_{y}} may not appear to be extended to the point 150. The amount Y of added yellow primary color may be adjustable in order to tradeoff accurate color hues with increased image brightness. The color accuracy may be maximum near Y=0. Some embodiments of the present invention may provide a method for a user to adjust the value of Y or the values of λ₁,λ₂, and λ₃.

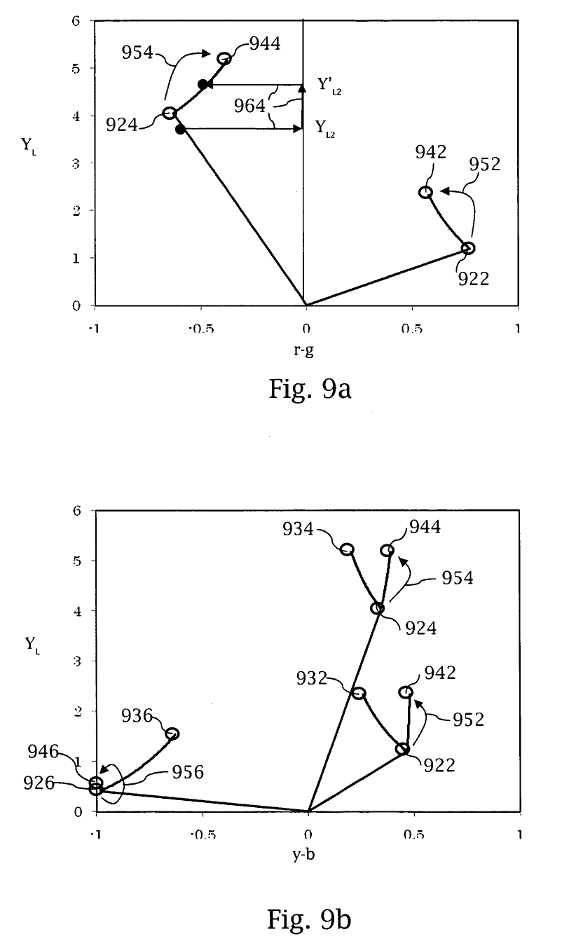

FIG. 9a shows the luminosity Y_{L} of the primary colors {R′ₛ,G′ₛ} as a function of a red-green chromaticity coordinate r-g. The points with no added fourth primary colors are Rₛ 922, Gₛ 924, and Bₛ 926. The points with Y=0.2 added yellow primary colors are R′ₛ 942, and G′ₛ 944. The point with λ₃=0.2 added blue light is B′ₛ 946. FIG. 9a demonstrates that the brightness of the primary colors {R′ₛ,G′ₛ} increases with increasing amount Y of the yellow primary color P_{y}. The chromaticity r-g decreases with increasing amount Y of the yellow primary color P_{y}. However the saturation of the primary colors {R′ₛ,G′ₛ} may be nearly unchanged with increasing amount Y of yellow primary color P_{y}.

FIG. 9b shows the luminosity Y_{L} of the primary colors {R′ₛ,G′ₛ,B′ₛ} as a function of a yellow-blue chromaticity coordinate y-b where y=(r+g)/2. The points with no added fourth primary colors are Rₛ 922, Gₛ 924, and Bₛ 926. The points with W=0.2 added white primary colors are R′ₛ 932, G′ₛ 934, and B′ₛ 936. The points with Y=0.2 added yellow primary colors are R′ₛ 942, and G′ₛ 944. The point with λ₃=0.2 added blue light is B′ₛ 946. FIG. 9b shows that the brightness of the primary colors {R′ₛ,G′ₛ,B′ₛ} increases with increasing amount Y of the yellow primary color P_{y} and additional blue light. Furthermore, the chromaticity coordinate y-b of the primary colors {R′ₛ,G′ₛ,B′ₛ} may be nearly unchanged with increasing amount Y of the yellow primary color P_{y} and with increasing the blue light.

FIGS. 9a-b and 10 show that the color gamut does not change substantially when additional blue light with the chromaticity of the blue primary color is added to the blue primary color. However, the location of the white point of the primary colors {R′ₛ,G′ₛ,B′ₛ} may depend on the ratio of the amount of the additional blue light to the amount of yellow light. The white point 160 of the sRGB color space is shown in FIG. 10. In the case of Y=0.2 and no added blue light λ₃=0, the white point 164 of the primary colors {R′ₛ,G′ₛ,B′ₛ} is shifted toward the yellow primary color P_{y} 150 by a small amount as shown in FIG. 10. When blue light is added with an amount necessary to compensate for the added yellow light, the white point 664 of the primary colors {R′ₛ,G′ₛ,B′ₛ} may be shifted back to the chromaticity of the sRGB white point 160.

One advantage of using a yellow primary color to brighten an image over other hues is that by using a yellow primary color P_{y} to increase the brightness of the red, green, and blue primary colors of a display apparatus, the white point may be shifted along a curve 166 of natural white points. The addition of yellow light may simulate the addition of sunlight to an image which the human visual system is well adapted and accustom to. Natural white points have the chromaticity coordinates of radiating bodies of various temperatures. The sRGB white point 160 has a color temperature of about 6500K. The white point 164 for Y=0.2 added yellow light and no added blue light has a color temperature of about 5500K. In the present example, the location of the yellow primary color was chosen to be centered near 577.5 nm in order that the white point 164 would be shifted along the curve of natural white points when the yellow light was added in equal amounts to the red Rₛ and green Gₛ primary colors λ₁=λ₂. Other yellow primary colors may be used in the methods of the present invention and added to the red and green primary colors in specific ratios to obtain a natural white point. Alternatively, the yellow primary color may be chosen to be comprised of the available yellow light produced by a particular light source.

A second example of the present invention is applied to the primary colors of the DCI (Digital Cinema Initiatives) specification widely used in digital cinema. The primary colors {R_{d},G_{d},B_{d}} of the DCI have CIE xyY coordinates of

| | x | y | Y(cd/m²) |
|---|---|---|---|
| R_{d}: | (0.68, | 0.32, | 10.1) |
| G_{d}: | (0.265, | 0.69, | 34.6) |
| B_{d}: | (0.15, | 0.06, | 3.31). |

In this example, the luminance of the DCI white point was normalize to one Y_{Lw}=1.0.

FIG. 11 shows (1) the color gamut 120 of the primary colors R_{d} 122, G_{d} 124, and B_{d} 126; (2) the color gamut 130 of the primary colors R′_{d} 132, G′_{d} 134, and B′_{d} 136 for a white primary color P₄ with a luminosity W of 0.2; and (3) the color gamut 140 of the primary colors R′ₛ 142, G′ₛ 144, and B′ₛ 146 for a yellow primary color P_{y} with a luminosity Y of 0.2. The color gamut 130 resulting from adding the white primary color P₄ is reduced in area and saturation compared with the color gamut 120 of the DCI primary colors. The color gamut 140 resulting from adding a yellow primary color P_{y} is reduced in area compared with the color gamut 120 of the sRGB primary colors however, the saturation is not significantly reduced. The DCI white point 260 may be shifted to the white point 264 for Y=0.2 added yellow light and no added blue light. In this example, the color gamut may be increased even less by the yellow primary color P_{y} than for the case of sRGB primary colors. The lack of contribution of the yellow primary color to the color gamut is often due to the ability of highly saturated yellow hues to be comprised of red and green primary colors.

The sRGB and DCI examples above demonstrate the advantages of the methods of the present invention. Adding a yellow primary color to red, green and blue primary colors may increase the brightness of the display without decreasing the saturation of the primary colors. The yellow primary color generally may have a luminance about equal to the red primary color or less and may substantially not increase the color gamut of the display apparatus.

Thus far, methods of transforming the primary colors {P₁,P₂,P₃} into primary colors {P₁′,P₂′,P₃′} have been discussed. In addition to adding blue light to the blue primary color, the methods of the present invention may be applied with adding green light to the blue primary color. The analysis is not discussed in detail herein however, one skilled in the art will understand how to apply the methods of the present invention to the case of using green light to brighten a blue primary color. The green light may be supplied by the green primary color and may be thought of as a hue shift.

Another embodiment of the present invention provides methods to transform colors represented by coordinates {a₁,a₂,a₃} of primary colors {A₁,A₂,A₃} into colors represented by coordinates {p₁,p₂,p₃,p₄} of primary colors {P₁,P₂,P₃,P₄} where P₁ is a red primary color, P₂ is a green primary color, P₃ is a blue primary color, and P₄ is a yellow primary color. The transformation H may be represented by functions pᵢ=pᵢ(a₁,a₂,a₃). The coordinates {p₁,p₂,p₃,p₄} of primary colors {P₁,P₂,P₃,P₄} may be represented by coordinates {p′₁,p′₂,p′₃} of effective primary colors {P′₁,P′₂,P′₃} and a mapping M of the coordinates {p′₁,p′₂,p′₃} into coordinates {(p₁,y₁),(p₂,y₂),(p₃,y₃)} where the mapping M may be written as follows:

M

p′₁→(pᵢ,yᵢ),

p′₂→(p₂,y₂), and

p′₃→(p₃,y₃),

and where colors {p′₁P′₁,p′₂P′₂,p′₃P′₃} may be obtained from the following relationships:

p′₁P′₁=p₁P₁+y₁P₄,

p′₂P′₂=p₂P₂+y₂P₄, and

p′₃P′₃=p₃P₃+y₃P₄.

Herein the {P′₁,P′₂,P′₃} are called effective primary colors because their spectra change depending on the coordinates {p′₁,p′₂,p′₃}. The mapping M may be comprised of the following elements {E₁,E₂,E₃} defined as follows:

E₁: {1,0,0}→{(1,λ₁),(0,0),(0,0)}

E₂: {0,1,0}→{(0,0),(1,λ₂),(0,0)} and

E₃: {0,0,1}→{(0,0),(0,0),(1+λ₃,0)}

where λ₁ and λ₂ are not equal to zero. Elements {E₁,E₂,E₃} of mapping M map the primary colors {P′₁,P′₂,P′₃} into primary colors {P₁,P₂,P₃,P₄} as follows:

E₁: P′₁=P₁+λ₁P₄,

E₂: P′₂=P₂+λ₂P₄, and

E₃: P′₃=(1+λ₃)P₃.

Herein color coordinates are scaled to span the range [0,1] unless otherwise implied by the context.

The transformation H comprises (1) transforming coordinates {a₁,a₂,a₃} of primary colors {A₁,A₂,A₃} into coordinates {p′₁,p′₂,p′₃}; (2) mapping the coordinates {p′₁,p′₂,p′₃} into coordinates {(p₁,y₁),(p₂,y₂),(p₃,y₃)} using a mapping M; and (3) displaying the coordinates {(p₁,y₁),(p₂,y₂),(p₃,y₃)} in primary colors {P₁,P₂,P₃,P₄}. Alternatively, step (1) may transform the coordinates {c₁,c₂,c₃} of color space into coordinates {p′₁,p′₂,p′₃}. Preferably the colors {p′₁P₁,p′₂P₂,p′₃P₃} may accurately represent the colors {a₁A₁,a₂A₂,a₃A₃} or the colors of the coordinates {c₁,c₂,c₃}.

The mapping M may map the coordinates {p′₁,p′₂,p′₃} into coordinates {(p₁,y₁),(p₂,y₂),(p₃,y₃)} in a variety of methods. The coordinates {p′₁,p′₂,p′₃} may be considered as the coordinates of the primary colors {P₁,P₂,P₃} before the primary colors {P₁,P₂,P₃} are transformed into the effective primary colors {P′₁,P′₂,P′₃}. The coordinates {(p₁,y₁),(p₂,y₂),(p₃,y₃)} or {p₁,p₂,p₃,p₄} may be considered as the coordinates of the primary colors {P₁,P₂,P₃,P₄} after the primary colors {P₁,P₂,P₃} have been transformed into the effective primary colors {P′₁,P′₂,P′₃}. This perspective allows the mapping M to be represented geometrically in plots of the primary colors {P₁,P₂,P₃} and {P′₁,P′₂,P′₃}. The mappings E₁, E₂, and E₃ of the primary colors {P₁,P₂,P₃} into primary colors {P′₁,P′₂,P′₃} are represented by arrows 952, 954 and 956 in FIGS. 9a-b respectively.

The mapping M may comprise elements {E₄,E₅,E₆} which map the high saturation colors p′₁P₁, p′₂P₂, and p′₃P₃ into colors p′₁P′₁, p′₂P′₂, and p′₃P′₃. The elements {E₄,E₅,E₆} may be given by

E₄: {p′₁,0,0}→{(p₁,y₁),(0,0),(0,0)},

E₅: {0,p′₂,0}→{(0,0),(p₂,y₂),(0,0)}, and

E₆: {0,0,p′₃}→{(0,0),(0,0),(p₃+y₃,0)}.

Elements {E₄,E₅,E₆} of mapping M map the primary colors {p′₁P′₁,p′₂P′₂,p′₃P′₃} into primary colors {P₁,P₂,P₃,P₄} as follows:

E₄: p′₁P′₁=p₁P₁+y₁P₄,

E₅: p′₂P′₂=p₂P₂+y₂P₄, and

E₆: p′₃P′₃=(p₃+y₃)P₃.

Elements E₅ is depicted in FIG. 9a by arrows 664. The luminance Y_{Li} of color p′ᵢPᵢ may be increased to luminance Y′_{Li} of color p′ᵢP′ᵢ by the mapping M. The elements {E₄,E₅,E₆} of mapping M may be selected to satisfy a function Y′_{Li}=Fᵢ(Y_{Li}) for the highly saturated colors. For example functions Fᵢ may be of the form Y′_{Li}=fᵢY_{Li} where fᵢ are constants. Then the luminance of the highly saturated colors p′₁P₁, P′₂P₂, and p′₃P₃ may be increased proportionally by the yellow primary color P_{y}.

An example of mapping the high saturation colors p′ᵢPᵢ into colors pᵢPᵢ+yᵢP_{y} is depicted in FIG. 8. The curve 810 represents the function pᵢ=pᵢ(p′ᵢ). The curve 812 represents the function yᵢ=yᵢ(p′ᵢ). The curves 810 and 812 indicate that for low values of p′ᵢ the colors p′ᵢP′ᵢ may have chromaticity similar to the chromaticity of primary colors {P₁,P₂,P₃} and for high values of p′ᵢ the colors p′ᵢP′ᵢ may have chromaticity similar to the chromaticity of the effective primary colors {P′₁,P′₂,P′₃}. The functions pᵢ=pᵢ(p′ᵢ) and yᵢ=yᵢ(p′ᵢ) may have transition features in transition regions which smooth out the changes in hue of the primary colors {P₁′,P₂′,P₃′}. The dotted lines 820 and 822 in FIG. 8 depict examples of these transition features. The functions pᵢ=pᵢ(p′ᵢ) and yᵢ=yᵢ(p′ᵢ) may have the forms:

Outside the transition regions

pᵢ=α₁p′ᵢ, yᵢ=0 for 0<p′ᵢ<1/α₁−τ₁ and

pᵢ=1, yᵢ=(λᵢ/(1−α₁))(p′ᵢ−1/α₁) for 1/α₁+τ₂<p′ᵢ<1.

Inside the transition regions {1/α₁−τ₁<p′ᵢ<1/α₁+τ₂}

pᵢ=α₁p′ᵢα₂(p′ᵢ−1/α₁−τ₁)², and

yᵢ=(λᵢ/(1−α₁))(p′ᵢ−1/α₁)+α₃(p′ᵢ−1/α₁−τ₁)².

The parameters α₁, α₂, α₃, τ₁, and τ₂ may be chosen to smooth out the changes in hue near p′ᵢ=1/α₁. These and similar methods of smoothing out hue changes may be used throughout the color space and are aspects of the present invention.

The highly saturated colors between red and green may have the form p′₁P₁+p′₂P₂. Mapping M may map these colors into colors p′₁P′₁+p′₂P′₂=p₁P₁+p₂P₂+(y₁+y₂) P₄ using mapping functions pᵢ=pᵢ(p′ᵢ) and yᵢ=yᵢ(p′ᵢ) similar to the case of colors p′ᵢPᵢ treated above. More generally, the mapping M may comprise element E₇ which maps the high saturation colors P′₁P₁+p′₂P₂ between red and green into a linear combination of colors p′₁P′₁ and p′₂P′₂. The element E₇ may be given by

E₇: {p′₁,p′₂,0}→{β₁₂(p₁,y₁),β₂₁(p₂,y₂),(0,0)}

where β₁₂ and β₂₁ may be functions of the chromaticity of the color p′₁P₁+p′₂P₂.

Element E₇ of mapping M may map the primary colors β₁₂p′₁P′₁+β₂₁p′₂P′₂ into primary colors {P₁,P₂,P₃,P₄} as follows:

E₇: β₁₂p′₁P′₁+β₂₁p′₂P′₂=β₁₂p₁P₁+β₂₁p₂P₂+(β₁₂y₁+β₂₁y₂)P₄.

Similarly, the mapping M may comprise element E₈ which maps the high saturation colors p′₁P₁+p′₃P₃ between red and blue into a linear combination of colors p′₁P′₁ and p′₃P′₃. The elements E₈ may be given by

E₈: {p′₁,0,p′₃}→{β₁₂(p₁,y₁),(0,0),β₃₁(p₃+y₃,0)}

where β₁₃ and β₃₁ may be functions of the chromaticity of the color p′₁Pᵢ+p′₃P₃.

Element E₈ of mapping M may map the primary colors P₁₃p′₁P′₁+β₃₁p′₃P′₃ into primary colors {P₁,P₂,P₃,P₄} as follows:

E₈: β₁₃p′₁P′₁+β₃₁p′₃P′₃=β₁₃p₁P₁+β₃₁(p₃+y₃)P₃+β₁₃y₁P₄.

Similarly, the mapping M may comprise element E₉ which maps the high saturation colors p′₂P₂+p′₃P₃ between green and blue into a linear combination of colors p′₂P′₂ and p′₃P′₃. The elements E₉ may be given by

E₉: {0,p′₂,p′₃)}→{(0,0),β₂₃(p₂,y₂),β₃₂(p₃+y₃,0)}

where β₂₃ and β₃₂ may be functions of the chromaticity of the color p′₂P₂+p′₃P₃.

Element E₉ of mapping M may map the primary colors β₂₃p′₂P′₂+β₃₂p′₃P′₃ into primary colors {P₁,P₂,P₃,P₄} as follows:

E₉: β₂₃p′₂P′₂+β₃₂p′₃P′₃=β₂₃p₂P₂+β₃₂(p₃+y₃)P₃+β₂₃y₂P₄.

Desaturated colors may have the form p′₁P₁+p′₂P₂+p′₃P₃. Mapping M may map these colors into colors p′₁P′₁+p′₂P′₂+p′₃P′₃=p₁P₁+p₂P₂+p₃P₃+(y₁+y₂)P_{y}+y₃P₃ using mapping functions pᵢ=pᵢ(p′ᵢ) and yᵢ=yᵢ(p′ᵢ) similar to the case of colors p′ᵢPᵢ treated above. More generally, the mapping M may comprise element E₁₀ which maps the high saturation colors P′₁P₁+p′₂P₂+p′₃P₃ into a linear combination of colors p′₁P′₁, P′₂P′₂ and p′₃P′₃. The element E₁₀ may be given by

E₁₀: {p′₁,p′₂,p′₃}→{β₁(p₁,y₁),β₂(p₂,y₂),β₃(p₃+y₃,0)}

where β₁, β₂ and β₃ may be functions of the chromaticity of the color p′₁P₁+p′₂P₂+P′₃P₃.

Element E₁₀ of mapping M may map the primary colors β₁p′₁P′₁+β₂p′₂P′₂+β₃p′₃P′₃ into primary colors {P₁,P₂,P₃,P₄} as follows:

E₁₀: β₁p′₁P′₁+β₂p′₂P′₂+β₃p′₃P′₃=β₁p₁P₁+β₂p₂P₂+β₃(p₃+y₃)P₃+(β₁y₁+β₂y₂)P₄.

If the additional blue light y₃ is not large enough to balance the added yellow primary color, the white point may be shifted toward yellow. In order to perform corrections to the white point it may be beneficial to transform the primary colors {P′ ₁,P′₂,P′₃} into hues coordinates before using a mapping M. Hue coordinates are often defined as follows:

gray, k′=MIN(P′₁,P′₂,P′₃),

yellow, y′=MAX(P′₁,P′₂)−gray,

cyan, c′=MAX(P′₂,P′₃)−gray,

magenta, m′=MAX(P′₁,P′₃)−gray,

red, r′=P′₁−yellow−magenta−gray,

green, g′=P′₂−cyan−yellow−gray, and

blue, b′=P′₃−magenta−cyan−gray.

The hue coordinates {k′,y′,c′,m′,r′,g′,b′} may be obtained from the coordinates {a₁,a₂,a₃}. Hue coordinates x′ᵢ may be mapped into hue coordinates of the primary colors {P₁,P₂,P₃,P₄} using functions of the form xᵢ=xᵢ(k′,y′,c′,m′,r′,g′,b′) and yₓ=yₓ(k′,y′,c′,m′,r′,g′,b′) which may reduce to functions of the form

k=k(k′)+yₖ(k′),

y=y(y′)+y_{y}(y′),

c=c(c′)+y_{c}(c′),

m=m(m′)+yₘ(m′),

r=r(r′)+yᵣ(r′),

g=g(g′)+y_{g}(g′), and

b=b(b′)+y_{b}(b′).

Then the primary color coordinates {p₁,p₂,p₃,p₄} may be obtained from the hue coordinates x′ as follows

p₁=r+y+m+k,

p₂=g+c+y+k,

p₃=b+m+c+k, and

p₄=yₖ+y_{y}+y_{c}+yₘ+yᵣ+y_{g}+y_{b}.

The hue functions x=x(x′) may reduce to the forms pᵢ=pᵢ(p′ᵢ) and yᵢ=yᵢ(p′ᵢ) at high saturation.

In addition to the examples above in some embodiments of the present invention, the mapping M may comprise more complex nonlinear functions which may include gamma corrections. In some embodiments of the present invention, the mapping M may be implemented with lookup tables which avoid invoking a specific functional relationship between primary colors {P₁,P₂,P₃,P₄} and effective primary colors {P′₁,P′₂,P′₃}.

In another method of the present embodiment, a yellow primary color P₄=P_{y} may be added to the red P₁ and green P₂ primary colors and the blue primary color P₃ may be brightened using the green primary P₂ as follows:

P′₁=P₁+λ₁P₄,

P′₂=P₂+λ₂P₄, and

P′₃=P₃+λ₃P₂.

The methods described herein for increasing the brightness of primary colors {P₁,P₂,P₃} using a fourth primary color P₄ are also applicable increasing the brightness of four or more primary colors {P₁,P₂,P₃,P₄} using a fifth yellow primary color P₅. The methods discribed herein do not exclude the cases of more than four primary colors. For example the brightness of red, green, cyan and blue primary colors may be increased by a yellow primary color using methods of the present invention by one skilled in the art.

Another embodiment of the present invention is a method of providing a white primary color which may be used to brighten a display apparatus. In some display apparatus, the light used in a white primary color may reduce the light available to red, green and blue primary colors. Since the white primary may be only partially used for highly saturated colors, the result may be a dimming of the highly saturated colors. The present invention provides methods of creating a white primary color from light spectra which may be substantially not used by the red, green and blue primary colors. Display apparatus which comprise light sources which may be UHP or Xenon arc lamps, fluorescent sources or other light sources may have surplus yellow and cyan light which may be discarded in the process of creating the red, green and blue primary colors.

The present invention provides a method to combine this discarded yellow and cyan light into a white primary color. The yellow spectra may be centered near about 570-590 nm while the cyan spectra may be centered in a range from about 500 nmm to about 480 nm. Cyan light centered near 490-500 nm is the typical region discarded when creating green and blue primary colors however, cyan light near 490-500 nm and yellow light near 580 nm may combine to provide a greenish-white primary color. In order to provide a more natural white primary color, blueish light near 480 nm may be combined with the yellow light near 580 nm. However, using blueish light near 480 nm may reduce the brightness of the blue primary color causing the white point of the red, green and blue primary colors to shift toward yellow. In order to brighten the blue primary color, a small amount of blueish-green light in the range of about 500-530 nm may be added to the blue primary color. FIG. 5 depicts the spectra of red R, green G, and blue B primary colors. FIG. 5 also depicts a yellow spectra y and a cyan or blue spectra B′. The yellow Y and cyan B′ spectra may be combined by the present invention to provide a white primary color. If the cyan spectra B′ is near 480 nm, the blue primary color spectra B may include a spectra of the blueish-green light at longer wavelengths than the spectra B′.

Another embodiment of the present invention is a method of providing a white primary color comprising combining a spectra of yellow light centered near 570-590 nm with a spectra of blue light centered near 475-485 nm. In addition a blue primary color may be comprised of a spectra of blue light centered at wavelengths shorter than about 475 nm and a spectra of blueish-green light centered at wavelengths longer than about 500 nm.

Many types of display apparatus may provide four primary colors of the present invention. Some display types may conveniently provide a yellow primary color whose spectra does not substantially overlap the spectra of red, green, and blue primary colors. Other display types may conveniently provide a yellow primary color whose spectra substantially overlaps the spectra of the red or green primary colors. Both types of yellow primary color may be used in the methods of the present invention to brighten an image.

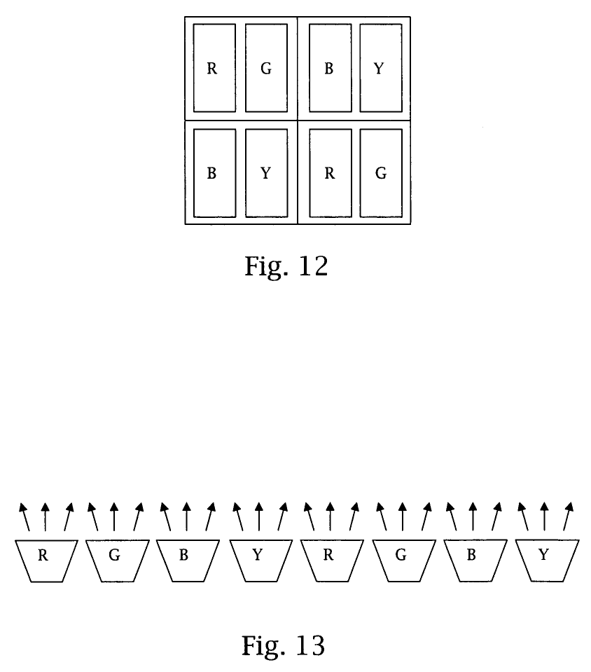

FIG. 12 depicts a pixel pattern for providing four primary colors in a spatially multiplexed display apparatus. Flat panel displays, CRT's and some digital projectors may use spatially multiplexed primary colors. The pixel pattern depicted in FIG. 12 is one of many pixel patterns in the prior art for providing four primary colors. This pixel pattern has been used to provide red, green, blue and white primary colors. Another embodiment of the present invention is a display apparatus providing four spatially multiplexed primary colors {P₁,P₂,P₃,P₄} where primary P₁ is red, primary color P₂ is green, primary color P₃ is blue, and primary color P₄ is yellow. The pixel pattern of FIG. 12 has been used in the prior art with a white primary color to enhance the brightness of a display apparatus. At the same time, the pixel pattern has been used to increase the resolution of vertical and horizontal lines. In the present invention, the yellow and blue primary colors may be combined to form a white color. If the blue primary color has sufficient brightness, the blue primary color may also combine with the red and green primary colors to form a white color. Therefore embodiments of the present invention which provide a sufficiently strong blue primary color and a yellow primary color may have the advantages of a white primary color without the disadvantages of desaturating the colors of an image. Like a white primary color, a yellow primary color of the present invention may be relatively efficient at passing light from a backlight.

FIG. 13 depicts an array of spatially multiplexed light emitting primary colors. The light emitting sources may be LED's or phosphor emitters such as in CRT's or plasma displays. Another embodiment of the present invention is an array of spatially multiplexed light emitters providing four primary colors {P₁,P₂,P₃,P₄} where primary color P₁ is red, primary color P₂ is green, primary color P₃ is blue, and primary color P₄ is yellow. The light emitters may be arranged in the pixel pattern of FIG. 12 or another advantageous pixel pattern of the prior art.

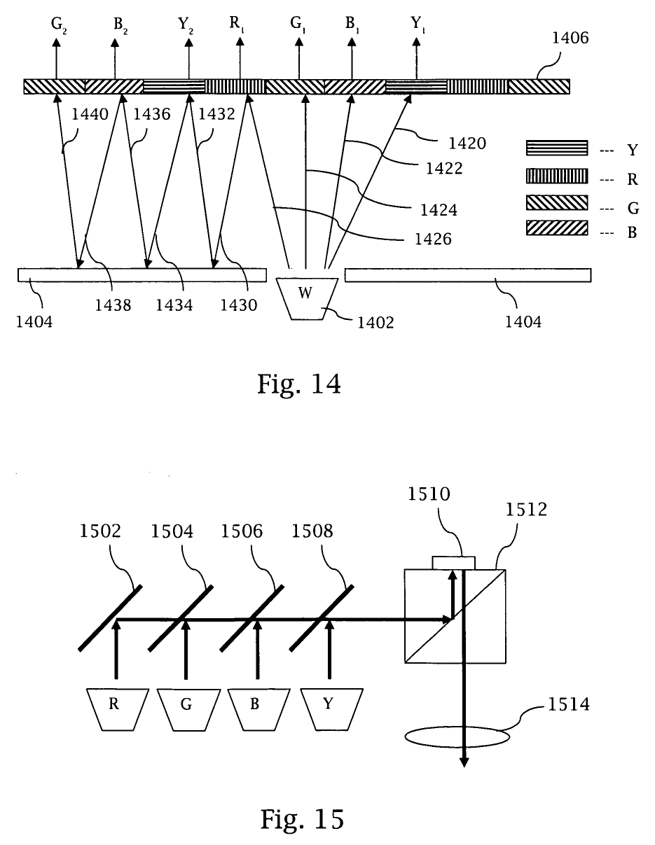

FIG. 14 depicts a backlight for an LCD display device. The backlight provides an example of a display apparatus which may use recycled light. The backlight is comprised of one or more light sources 1402, a reflective surface 1404, and a patterned color filter 1406. Light 1426 from the light source 1402 may be incident on a red filter segment. The red light R₁ in the light 1402 may pass through the filter segment while the reflected light 1430 may contain yellow, green, and blue light. Light 1430 may reflect off surface 1404 and light 1432 may be incident on a yellow filter segment. The yellow light Y₂ may pass through the filter segment while the reflected light 1434 may contain green and blue light. The light 1434 may reflect off surface 1404 and light 1436 may impinge on a blue filter segment. The blue light B₂ may pass through the blue filter segment. The reflected light 1438 may contain green light. The light 1438 may reflect off surface 1404. Light 1440 may be incident on a green filter segment. The green light G₁ may pass through the green filter segment. yellow 1420, blue 1422, green 1424, and red 1426 from the light source that is incident on filter 1406 may pass through the corresponding color filter segments. The reflected light may eventually reflect onto another corresponding color filter segment and pass through. Therefore, the reflective surfaces increase the efficiency of the backlight. The backlight of FIG. 14 is designed to have high efficiency by repeatedly reflecting light until the light passes through a corresponding filter segment or is attenuated.

Another embodiment of the present invention is a LCD display device with a backlight which recycles reflected light. In this embodiment, a yellow primary color may conveniently have a spectra which does not substantially overlap the spectra of the red, green, and blue primary colors. If the spectra were to overlap significantly, the brightness of the red, green and blue primary colors may decrease in brightness due to the yellow filter segments. In another embodiment of the present invention, the yellow segments may be white segments which pass a spectra of yellow light and a spectra of cyan or blue light.

FIG. 15 depicts a portion of a projector display apparatus with a single display panel 1510 and four light sources R, G, B, and Y. The R light source emits red light. The G light source emits green light. The B light source emits blue light. The Y light source emits yellow light. The red, green, blue, and yellow light may be combined by dichroic mirrors 1502, 1504, 1506, and 1508. The red, green and blue and yellow light may be modulated with primary color images using the display panel 1510. If display panel 1510 is an LCOS panel, a polarizing beam splitter 1512 may filter the modulated image light through the projection lens 1514. The light sources may be rapidly switches off and on to create time sequential primary color images. Another embodiment of the present invention provides four primary color images time sequentially where one primary color is red, one primary color is green, one primary color is blue and one primary color is yellow. The yellow primary color image may be used to brighten the displayed red, green and blue images using the methods of the present invention.

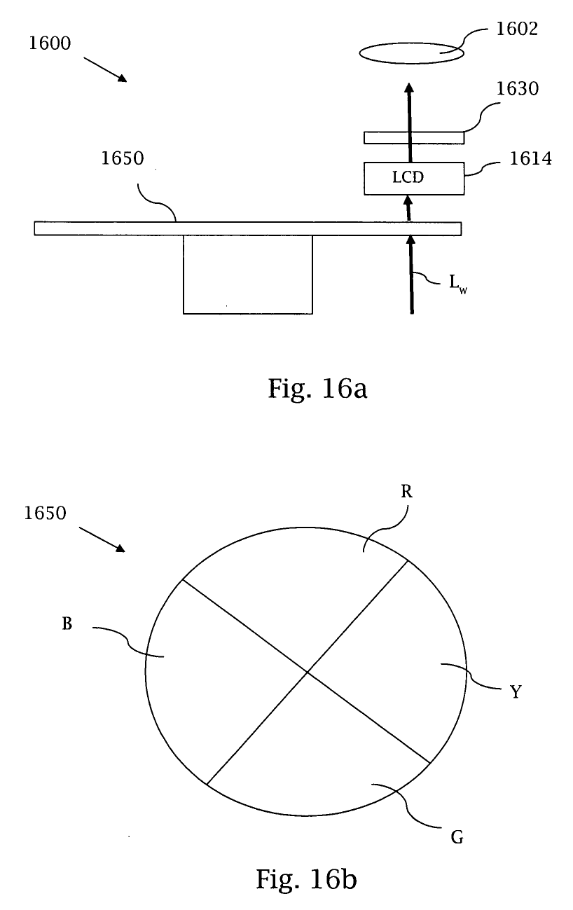

FIG. 16a depicts another example of a time sequential method of providing primary color images. A color wheel 1650 may split white light L_{w} into primary color light segments. An LCD device 1614 may modulate the primary color light with primary color images. A projection lens may project the primary color images. The color wheel 1650 depicted in FIG. 16b may provide four primary color light segments. Another embodiment of the present invention is a display apparatus with a color wheel and a display panel which produces a red, green, blue and yellow primary color images. The yellow primary color image may be used to brighten the displayed red, green, and blue images using the methods of the present invention.

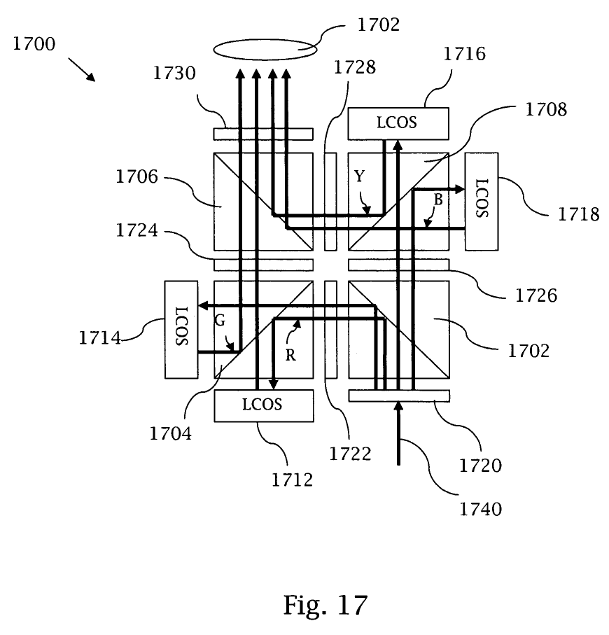

FIG. 17 shows an optical assembly of a four panel LCOS projector which may provide four primary colors {P₁,P₂,P₃,P₄} where primary color P₁ is red, primary color P₂ is green, primary color P₃ is blue, and primary color P₄ is yellow. The spectra of the yellow primary color P₄ may substantially not overlap the spectra of the primary colors {P₁,P₂,P₃}. In another embodiment of the present invention, n projector with four LCOS panels may be used to provide four primary colors {P₁,P₂,P₃,P₄} where primary color P₁ is red, primary color P₂ is green, primary color P₃ is blue, and primary color P₄ is yellow wherein the methods of the present invention may be used to brighten an image.

FIG. 17 depicts an optical assembly 1700 which may be part of a display apparatus of the present invention comprising four liquid crystal on Silicon (LCOS) display panels and four polarization beam splitters (PBS). The configuration is similar to the QuadColor™ architecture from Colorlink. There are many variations of this general architecture which will be obvious to those skilled in the art. The optimal pairing of primary colors may depend on the choice of the wavelengths of the primary color P₄. In FIG. 17, polarized light 1740 comprising the spectra of the primary colors {P₁,P₂,P₃,P₄} passes through a CSPF 1720. CSPF 1720 switches the polarization state of the spectra of two primary colors {P₂,P₄}. The spectra of the primary colors {P₁,P₂,P₃,P₄} enters a first PBS 1702. PBS 1702 divides the primary colors into two light bundles. The spectra of primary colors {P₂,P₄} pass through the first PBS 1702 and pass through a second CSPF 1726. CSPF 1726 switches the polarization state of the spectra of the primary color P₄. The spectra of primary colors {P₂,P₄} enters a second PBS 1708 which separates the primary colors into a first and second light bundles comprising primary colors P₂ and P₄ respectively. The spectra of primary color P₄ passes through the PBS 1708 and may be incident on a first LCOS panel 1716 and may be reflected back toward PBS 1708. The first panel 1716 imparts a primary image to the spectra of primary color P₄. The spectra of primary color P₂ may be reflected by PBS 1708 and may be incident on a second LCOS panel 1718 and may be reflected back toward PBS 1708. The second panel 1718 imparts a primary image to the spectra of primary color P₂. The second PBS 1708 combines the light bundles of the primary colors {P₂,P₄} and directs them out of PBS 1708.

The spectra of primary colors {P₁,P₃} may be reflected by the first PBS 1702 and pass through a third CSPF 1722. CSPF 1722 switches the polarization state of the spectra of the primary color P₃. The spectra of primary colors {P₁,P₃} enters a third PBS 1704 which separates the primary colors into a third and fourth light bundles comprising primary colors {P₁,P₃} respectively. The spectra of primary color P₃ passes through the PBS 1704 and may be incident on a third LCOS panel 1714 and may be reflected back toward PBS 1704. The third panel 1714 imparts a primary image to the spectra of primary color P₃. The spectra of primary color P₁ may be reflected by PBS 1704 and may be incident on a fourth LCOS panel 1712 and may be reflected back toward PBS 1704. The second panel 1712 imparts a primary image to the spectra of primary color P₁. The third PBS 1704 combines the light bundles of the primary colors {P₁,P₃} and directs them out of PBS 1704.

The spectra of primary colors {P₂,P₄} passes through a fourth CSPF 1728. The CSPF 1728 switches the polarization state of the spectra of primary color P₄. The spectra of primary colors {P₂,P₄} may be reflected by a fourth PBS 1706. The spectra of primary colors {P₁,P₃} passes through a fifth CSPF 1724. The CSPF 1724 switches the polarization state of the spectra of primary color P₃. The spectra of primary colors {P₁,P₃} pass through a fourth PBS 1706. PBS 1706 combines the spectra of the primary colors {P₂,P₄} and the spectra of the primary colors {P₁,P₃}. The spectra of primary colors {P₁,P₂,P₃,P₄} pass through a projection lens 1702. The spectra of the primary colors {P₁,P₂,P₃,P₄} may pass through a fifth CSPF 1730. CSPF 1730 may switch the polarization state of the primary colors {P₁,P₂} or {P₂,P₄} to obtain one polarization state pi for all primary colors {P₁,P₂,P₃,P₄}. Or CSPF 1730 may switch the polarization state of the primary color P₂ to obtain a first polarization state p₁ for all primary colors {P₁,P₂,P₃} and a second polarization state p₂ for primary color P₄Q. The present embodiment may include additional optical components that condition the spectra of the primary colors and the paths of the primary colors.

In addition to the advantages outlined above, aspects of the present invention are applicable to methods of displaying of stereoscopic images which have been previously described in United States patent application titled “Display Of Generalized Anaglyphs Without Retinal Rivalry”. by inventor Monte J. Ramstad which is incorporated in its entirety by reference hereto.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

I claim:

1. A method of increasing the brightness of an image comprising:
a display apparatus capable of displaying four primary colors {P₁,P₂,P₃,P₄);
wherein primary color P₁ is red;
primary color P₂ is green;
primary color P₃ is blue;
primary color P₄ is yellow;
an image representable in coordinates {c₁,c₂,c₃};
transforming coordinates {c₁,c₂,c₃} into coordinates {p′₁,p′₂,p′₃};
mapping coordinates {p′₁,p′₂,p′₃} into coordinates {(p₁,y₁),(p₂,y₂),(p₃,y₃)} using a mapping M; and
displaying the image in colors p′₁P′₁+p′₂P′₂+p′₃P′₃=p₁P₁+y₁P_{y}+p₂P₂+y₂P₄+(p₃+y₃)P₃.

2. The method of claim 1 wherein the luminosity of primary color P₄ is approximately equal to the luminosity of primary color P₁ or less.

3. The method of claim 1 wherein the colors p′₁P₁+p′₂P₂+p′₃P₃ substantially represent the colors of the image represented in coordinates {c₁,c₂,c₃}.

4. The method of claim 1 wherein the spectra of the primary color P₄ is centered in the range of 570 to 580 nm.

5. The method of claim 1 wherein the spectra of the primary color P₄ does not substantially overlap the spectra of the primary colors {P₁,P₂,P₃}.

6. The method of claim 1 wherein the mapping M comprises:
element E₁: {1,0,0}→{(1,λ₁),(0,0),(0,0)};
element E₂: {0,1,0}→{(0,0),(1,λ₂),(0,0)};
element E₃: {0,0,1}→{(0,0),(0,0),(1+λ₃,0)}; and
wherein λ₁ and λ₂ are not zero
whereby color P′₁=P₁+λ₁P₄, color P′₂=P₂+λ₂P₄, and color P′₃=(1+λ₃)P₃.

7. The method of claim 6 wherein the white point of colors {P′₁,P′₂,P′₃} is shifted from the white point of colors {P₁,P₂,P₃} toward a natural white point.

8. The method of claim 6 wherein the blue light λ₃P₃ reduces the shift of the white point of colors {P′₁,P′₂,P′₃} from the white point of colors {P₁,P₂,P₃}.

9. The method of claim 6 wherein the values of {λ₁,λ₂} are selectable.

10. The method of claim 6 wherein the mapping M further comprises:
element E₄: {p′₁,0,0}→{(p₁,y₁),(0,0),(0,0)};
element E₅: {0,p′₂,0}→{(0,0),(p₂,y₂),(0,0)};
element E₆: {0,0,p′₃}→{(0,0),(0,0),(p₃+y₃,0)}; and
where p₁=p₁(p′₁), y₁=y₁(p′₁), p₂=p₂(p′₂), y₂=y₂(p′₂), p₃=p₃(p′₃), and y₃=y₃(p′₃)
whereby color p′₁P′₁=p₁P₁+y₁P₄, color p′₂P′₂=p₂P₂+y₂P₄, and color p′₃P′₃=(p₃+y₃)P₃.

11. The method of claim 10 wherein:
colors p′ᵢP′ᵢ , where p′ᵢ is small and has chromaticity coordinates close to the chromaticity coordinates of Pᵢ; and
colors p′ᵢP′ᵢ, where p′ᵢ is near 1 and has chromaticity coordinates close to the chromaticity coordinates of P′ᵢ;

12. The method of claim 10 wherein the mapping M further comprises:
element E₇: {p′₁,p′₂,0}→{β₁₂(p₁,y₁),β₂₁(p₂,y₂),(0,0)};
element E₈: {0,p′₂,p′₃)}→{(0,0),β₂₁(p₂,y₂),β₃₂(p₃+y₃,0)};
element E₉: {p′₁,0,p′₃}→{β₁₃(p₁,y₁),(0,0),β₃₁(p₃+y₃,0)};
β₁₂ and β₂₁ are functions of the chromaticity of p′₁P₁+p′₂P₂;
β₂₃ and β₃₂ are functions of the chromaticity of p′₂P₂+p′₃P₃;
β₁₃ and β₃₁ are functions of the chromaticity of p′₁P₁+p′₃P₃;
whereby
colors β₁₂p′₁P′₁+β₂₁p′₂P′₂=β₁₂p₁P₁+β₂₁p₂P₂+(β₁₂y₁+β₂₁y₂)P₄,
colors β₁₃p′₁P′₁+β₃₁p′₃P′₃=β₁₃p₁P₁+β₃₁(p₃+y₃)P₃+β₁₃y₁P₄, and
colors β₂₃p′₂P′₂+β₃₂p′₃P′₃=β₂₃p₂P₂+β₃₂(p₃+y₃)P₃+β₂₃y₂P_{y},

13. The method of claim 12 wherein the mapping M further comprises:
element E₁₀: {p′₁,p′₂,p′₃}→{β₁(p₁,y₁),β₂(p₂,y₂),β₃(p₃+y₃,0)};
β₁, β₂, and β₃ are functions of the chromaticity of p′₁P₁+p′₂P₂+p′₃P₃;
whereby
colors β₁p′₁P′₁+β₂p′₂P′₂+β₃p′₃P′₃=β₁p₁P₁+β₂p₂P₂+β₃(p₃+y₃)P₃+(β₁y₁+β₂y₂)P₄.

14. A method of providing a white primary color comprising:
a display apparatus providing primary colors {P₁,P₂,P₃};
a light source;
the spectra of primary colors P₁ devoid of a spectra of yellow light centered near 580 nm;
the spectra of primary colors P₂ devoid of a spectra of yellow light centered near 580 nm;
the spectra of primary colors P₂ devoid of a spectra of cyan or blue light centered near 480 to 500 nm;
the spectra of primary colors P₃ devoid of a spectra of cyan or blue light centered near 480 to 500 nm; and
combining a spectra of yellow light from the light source centered near 580 nm with a spectra of cyan or blue light from the light source centered near 480 to 500 nm into a white primary color.

15. The method of claim 14 further comprising:
the spectra of primary colors P₂ devoid of a spectra of cyan or blue light centered near 480 nm; and
the spectra of primary colors P₃ devoid of a spectra of cyan or blue light centered near 480 nm.

16. The method of claim 15 wherein the spectra of the primary color P₃ comprises:
a spectra of blue light centered at wavelengths shorter than about 475 nm; and
a spectra of light centered at wavelengths longer than about 500 nm.

17. A method of providing a white primary color comprising combining a spectra of yellow light centered near 570 to 580 nm with a spectra of blue light centered near 480 nm.

18. The method of claim 17 further comprising a method of providing a blue primary color comprising combining a spectra of blue light centered at wavelengths shorter than about 475 nm and a spectra of blueish-green or green light centered at wavelengths longer than about 500 nm.
